(19) United States
(12) Patent Application Publication
(10) Pub. No.: US 2005/0200143 A1
(43) Pub. Date: Sep. 15, 2005

(54) Highly articulated electromagnetic pick-up tool

(75) Inventor: Jeffery E. Maestas, Benbrook, TX (US)

Correspondence Address: BRACEWELL & PATTERSON, L.L.P., P.O. BOX 61389, HOUSTON, TX, 77208-1389, US

(73) Assignee: Lockheed Martin Corporation

(21) Appl. No.: 10/796,482

(22) Filed: Mar. 9, 2004

(51) Int. Cl. B25J 1/02

(52) U.S. Cl. 294/65.5

(57) ABSTRACT

A device uses an electromagnet to retrieve magnetic objects that are located in hard-to-reach places. The magnet is directed toward the object without being attracted to the surrounding components. The tool also incorporates a selectively actuated light for better illumination of the object in remote locations. The shaft of tool may flexible or telescopic, and incorporates a joint near the magnet and light for greater articulation. In one version, the tool uses as a contact and wiper system to deliver power to the magnet and light, and a magnetic strip to allow the tool to magnetically adhere to a toolbox.

### BACKGROUND OF THE INVENTION

1. Technical Field

The present invention relates in general to an improved tool for locating and acquiring small magnetic objects and, in particular, to an improved system, method, and apparatus for locating and acquiring magnetic objects with a highly articulated electromagnetic pick-up tool.

2. Description of the Related Art

Professional and home mechanics occasionally drop objects while working in confined spaces. For example, bolts, nuts, parts, and tools may be dropped by an automobile mechanic while working under the hood of a motor vehicle. The tool of choice to retrieve these dropped items is a simple, common pick-up tool with a permanent magnet attached to one end. There are a number of prior art solutions available for this type of tool including small pocket type tools, extendable tools, and tools with flexible shafts.

A common problem encountered by users of these tools occurs when the item dropped falls in a location that is manually inaccessible, such as in a small space between the body and engine of the vehicle. Prior art pick-up tools with permanent magnets are not only attracted to the dropped object itself, but also to the surrounding magnetic parts of the vehicle as well, which makes retrieval of the dropped object even more difficult.

For example, U.S. Pat. No. 1,535,618 shows a flexible electromagnet that may be bent in any desired shape to enable it to be introduced into inaccessible places to allow the user to enable the end of the magnet to reach objects that cannot otherwise be reached.

U.S. Pat. No. 1,772,126 discloses an automobile electromagnetic specialty tool primarily for use in garages which tool has a flexible shank containing electrical conductors attached to a single pole electromagnet having an adjustable fishing head and which is selectively connectable to a power source.

U.S. Pat. No. 2,993,723 discloses a magnetic retriever having a resiliently flexible shaft with a permanent magnet at one end so the retriever may be inserted through the dipstick passage into the crankcase of an engine to reach metallic objects inadvertently dropped into the crankcase.

U.S. Pat. No. 3,924,115 shows a portable hand-held device for locating and retrieving objects that has a source of electrical current controllable to energize a light source and an electromagnet. The electromagnet is disposed at one end of a flexible member or gooseneck that is connected to a hand-held device adjacent the light source. Optical fibers within the flexible member transmit light from the light source to the end of the flexible member.

Another type of retriever is shown in U.S. Pat. No. 4,253,697 in which a tool is disposed having a snap-lock handle connected to one end of a flexible cable. The other end has a releasable gripping end that may be mechanically or electromagnetically operated. A viewing system utilizes fiber optics.

While the devices described above and other similar devices which can be found in the prior art provide improved pick-up devices, there exists a need for an improved device of this type which is simple in construction, efficient and versatile to use and that provides the user with a greater ability to illuminate, view, and retrieve magnetic objects from hard-to-reach locations.

### SUMMARY OF THE INVENTION

One embodiment of a system, method, and apparatus for retrieving magnetic objects that are located in hard-to-reach places comprises a portable, battery-powered, electromagnetic pick-up tool with a momentary switch. This type of switch allows the user to direct the tool toward the object to be retrieved without the tool being attracted to the surrounding vehicle components. The switch also may employ a locking feature that is useful for some applications to alleviate the need for constant user engagement of the switch. Additionally, the tool incorporates a light, such as an LED, for better illumination of the object in remote locations.

The tool replaces standard magnetic pick-up tools in its ability to lift common fasteners and hand tools. In addition, the present invention requires no maintenance other than the replacement of its batteries from time to time. The electromagnet is capable of lifting magnetic objects up to a weight of approximately 5 pounds.

The tool of the present invention is small, lightweight, highly portable and uses commonly available batteries or rechargeable batteries such as those that use a charging stand as part of the tool system. For example, the device may utilize AA, AAA, C, D, or 9-volt batteries, depending on the application, desired power density, and the desired overall compactness and weight of the tool itself. Yet another option is to provide the power source through a connection to the battery of vehicle, such as the vehicle being worked on by the user. This solution provides a very high power density for the electromagnet.

The light source of the present invention may be provided by incandescent bulb, light emitting diode (LED), etc. Incandescent bulbs are widely available in many different sizes, and can be very compact. Small incandescent bulbs are relatively efficient in terms of power consumption. Additionally, many base configurations are available ranging from threaded-types to bayonet bulbs. LEDs are available in a wide variety of colors and use a fraction of the power of incandescent bulbs. LEDs are very compact, can operate over a relatively wide range of voltages while, and have a virtually indefinite life.

The shaft of the present invention may comprise several different types. For example, the shaft may comprise a straight shaft, with or without a “knuckle” (e.g., a ball joint) for additional articulation. The magnetic head is manipulated to different angles via the ball joint design. The shaft also may be provided in a variety of lengths. The shaft is hollow to allow conductors for the electromagnet and light to be readily passed through the shaft. In another embodiment, the shaft is extendable (e.g., telescopic and/or flexible) with the optional ball joint. Power is provided from the switch to the electromagnet and light via conductors that may be coiled or of the slip-type. If the shaft is hollow, the conductors are easily passed though the shaft. Other features of the present invention include snap-fits between its parts wherever possible so that the use of screws and other fasteners is very limited.

In one embodiment of the tool, a hollow, flexible shaft with a white LED light source is employed. The electromagnet is equipped with as many windings as practical to increase its electromotive force. Two 9-volt batteries are employed to assure adequate power is available. A two-position, momentary switch is mounted on a small printed wiring board (PWB) with a step-down voltage regulator. The handle may be formed from glass reinforced plastic (GRP), due to its moldability, strength, thermal stability and shock resistance. The handle has separate compartments for the PWB and batteries so that the PWB is not damaged when the batteries are replaced. The PWB is secured with a snap-in cover, and the battery cover only requires one screw to secure it to the handle. The electromagnet assembly is press fit into the distal end of the flexible shaft.

The conductors for the electromagnet windings and LED are fed through the shaft, and the shaft is threaded into the handle. The conductors may have shrink tubing placed around them to aid in running the conductors through the shaft. Small connectors are also available to eliminate having to solder conductors to the PWB at final assembly. The handle has threaded inserts molded into it for the battery cover screw and the flexible shaft. The flexible shaft is chrome plated for durability and the electromagnet has a protective sleeve over the windings to prevent damage.

In one alternate embodiment, a straight, extendable (e.g., telescopic) shaft is employed. The tool has an efficient mechanism to get power from the power source to the electromagnet and LED, such as a contact and wiper system, or a coiled wire system. In addition, the optional knuckle (e.g., universal or ball joint) accommodates the conductors as well. Still other embodiments include a flexible or extendable shaft with no light source, and a tool having a cast metal housing. The latter type of tool also may be provided with a magnetic strip on its side to allow it to magnetic adhere to a toolbox.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the invention, as well as others which will become apparent are attained and can be understood in more detail, more particular description of the invention briefly summarized above may be had by reference to the embodiment thereof which is illustrated in the appended drawings, which drawings form a part of this specification. It is to be noted, however, that the drawings illustrate only an embodiment of the invention and therefore are not to be considered limiting of its scope as the invention may admit to other equally effective embodiments.

FIG. 1 is an isometric view of one embodiment of a pick-up tool constructed in accordance with the present invention, and is shown with an extendable shaft in a collapsed position.

FIG. 2 is an isometric view of the pick-up tool of FIG. 1 with the extendable shaft in an extended position.

FIG. 3 is an enlarged isometric view of a distal end of the pick-up tool of FIG. 1.

FIG. 4 is an enlarged isometric view of the distal end of the pick-up tool of FIG. 3 illustrating a portion of a flexible range of the distal end.

FIG. 5 is an enlarged isometric view of one embodiment of the slip contacts located inside a knuckle on the distal end of the pick-up tool of FIG. 1.

FIG. 6 is an enlarged isometric view of one embodiment of the alignment ribs and sliding conductors located inside the shaft of the pick-up tool of FIG. 1.

FIG. 7 is a further enlarged isometric view of conductive strips located inside the shaft of the pick-up tool of FIG. 1.

FIG. 8 is an isometric view of a subassembly of the sliding contacts and conductive strips of FIGS. 6 and 7, respectively, in operation.

FIG. 9 is a side view of another embodiment of the pick-up tool constructed in accordance with the present invention.

FIG. 10 is an exploded isometric view of the pick-up tool of FIG. 9.

### DETAILED DESCRIPTION OF THE INVENTION

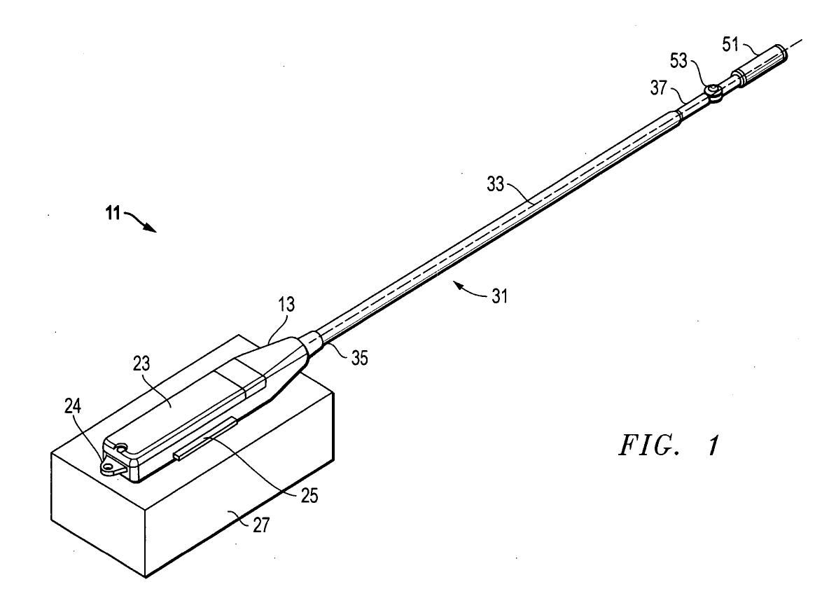

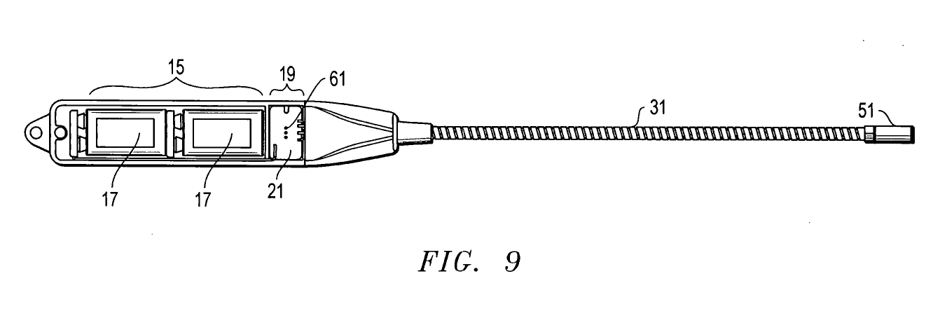

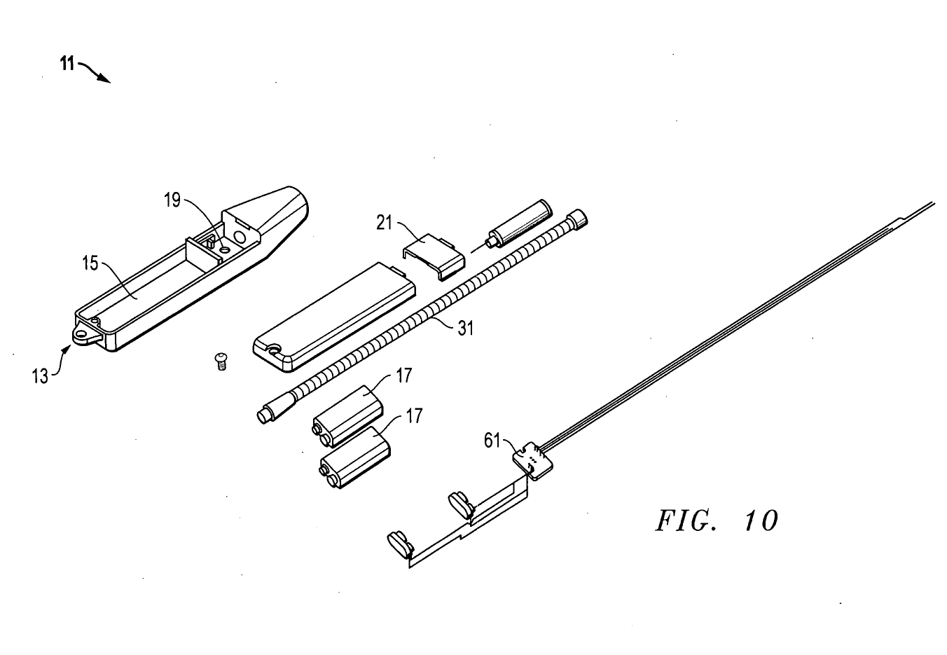

Referring to FIG. 1, one embodiment of a portable system and apparatus for retrieving magnetic objects that are located in hard-to-reach places, comprises a pick-up tool 11. The pick-up tool 11 has a small, lightweight, ergonomic handle 13. The handle 13 includes a first compartment 15 (FIGS. 9 and 10) for supporting a battery 17, a second compartment 19 for supporting a voltage regulator circuit on a circuit board 21, a cover 23 for concealing and providing access to only the first compartment 15, and a hanging loop 24. The handle 13 is also provided with a permanent magnet 25 mounted to the handle 13 and adapted to allow the pick-up tool 11 to magnetically adhere to and be retained on a magnetic object, such as a toolbox.

The pick-up tool 11 may be electrically powered by a variety of power sources including but not limited to conventional disposable batteries (e.g., AAA, AA, C, D, or 9-volt), rechargeable batteries that couple to a charging stand 27 (FIG. 1) to recharge the rechargeable batteries, and/or adapted to receive electrical power from a motor vehicle battery.

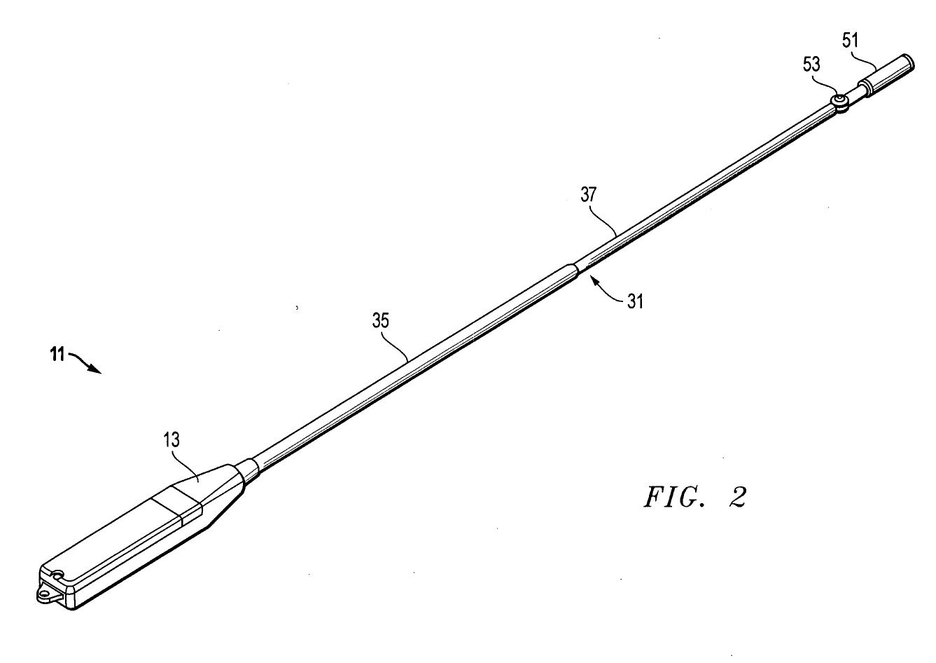

Referring again to FIGS. 1 and 2, the pick-up tool 11 further comprises a shaft 31 having an axis 33, a proximal end 35 mounted to the handle 13, and a distal end 37. The shaft 31 may be telescopic, flexible (see FIGS. 9 and 10), or both, with respect to the axis 33. A light 41 (FIG. 4) is mounted to the distal end 37 of the shaft 31 and coupled to the battery 17 for illuminating objects in remote locations. The light may comprise, for example, an incandescent bulb, a light emitting diode (LED), fiber optics, or still other types of lights. An LED light is desirable as it provides maintenance-free lighting for the life of the tool 11. The voltage regulator circuit 21 helps maintain maximum voltage to the light 41 for long life.

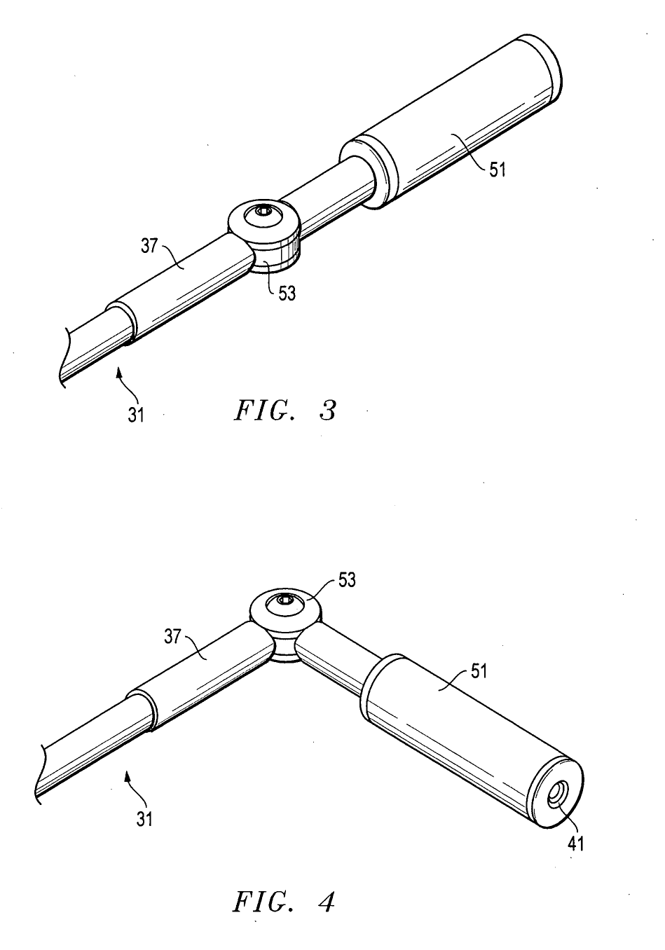

An electromagnet 51 (FIG. 3) is also mounted to the distal end 37 of the shaft 31 and coupled to the battery 17 for selectively attracting and retaining magnetic objects thereon. In the embodiment shown, the electromagnet 51 is tubular and the light 41 is located concentrically within the tubular electromagnet 51. The electromagnet 51 is sufficiently sized and powerful enough to lift small objects (e.g., fasteners, tools, etc.) up to a weight of approximately 5 pounds, depending on the power source. For example, one embodiment of the electromagnet 51 may comprise 400 to 500 windings of 30-gage wire.

A flexible end effector, “knuckle” or joint 53 is positioned in the shaft 31 between the distal end 37 of the shaft 31 and the electromagnet 51 for providing at least one additional degree of freedom of movement with respect to the shaft 31. The joint 53 allows the light 41 and electromagnet 51 to be positioned at a variety of angles for convenience. The joint 53 may comprise a universal, a ball joint, or other types of joints also allow the light 41 and electromagnet 51 to move, flex, and/or swivel with respect to the shaft 31.

A switch 61 is provided on the handle 13 for actuating the light 41 and electromagnet 51. In one embodiment, the switch 61 allows a user to direct the tool 11 toward an object to be retrieved without the tool 11 being attracted to surrounding magnetic components. To accomplish this, the switch 61 has a first position such that both the light 41 and the electromagnet 51 are off, a second position such that only the light 41 is on, and a third position such that both the light 41 and the electromagnet 51 are on. For example, the switch 61 may comprise a momentary, double-throw switch. This arrangement reduces power consumption as the dropped object is searched for by the user, and avoids unnecessary attraction of the electromagnet 51 to surrounding magnetic objects. Moreover, the switch 61 may be provided with a locking feature to alleviate a need for constant user engagement of the switch 61 in each of the positions.

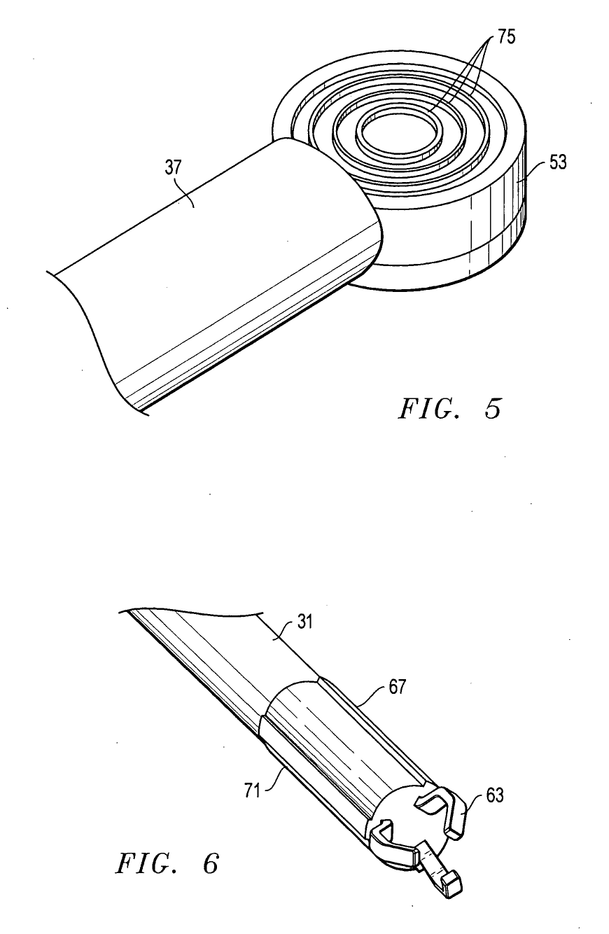

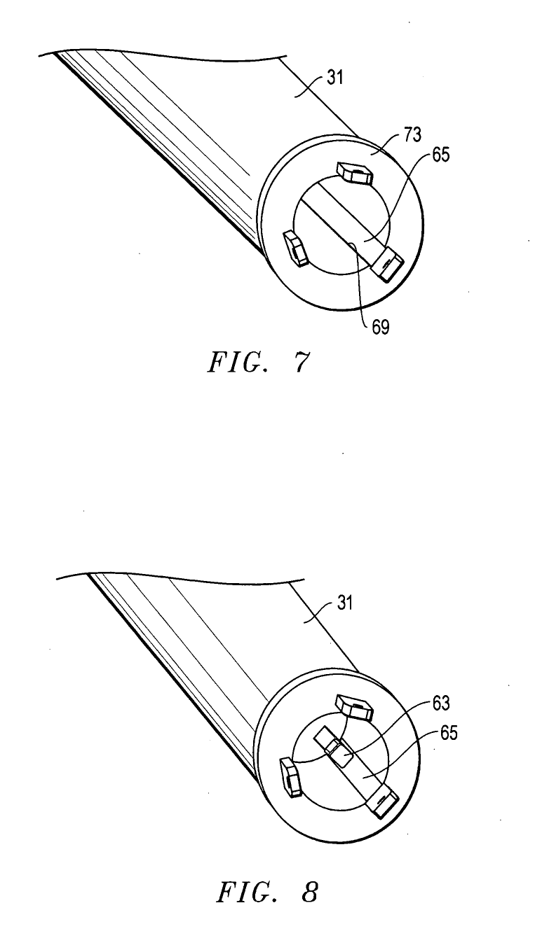

In order to provide power to the light 41 and electromagnet 51 in both the collapsed and extended positions, the shaft 31 is preferably hollow and contains sliding 63 and wiping 65 electrical contacts (FIGS. 6-8). Sliding conductors eliminate discrete conductors inside the sliding telescopic shafts 31 and the knuckle 53. The shaft 31 is equipped with alignment ribs 67 and alignment slots 69, respectively, to facilitate alignment between the sliding and wiping contacts 63, 65. The sliding and wiping contacts 63, 65 may be provided on inner glass-filled plastic insulators 71, 73, respectively, to insulate the shaft 31 therefrom. An alternative embodiment for transmitting power along the shaft 31 is shown in FIG. 5. “Slip” type contacts 75 or other types of electrical conductors may be used in the joint 53 and throughout the assembly to reliably deliver power therethrough.

The present invention has several advantages, including the ability to retrieve magnetic objects that are located in hard-to-reach places. The incremental acton of the double-throw switch allows the user to direct the illuminated tip of the tool toward remote objects without the tool being attracted to surrounding components. The locking feature on the switch alleviates the need for constant user engagement of the switch. The electromagnet is capable of lifting magnetic objects up to a weight of approximately 5 pounds. The tool is small, lightweight, highly portable and uses commonly available disposable batteries, rechargeable batteries, or through a connection to the battery of an automobile.

In addition, the shaft may be fixed, flexible, and/or extendable, and with or without an articulated joint for the light and magnet. The shaft is also hollow to allow conductors for the electromagnet and light to be readily passed through the shaft and knuckle via, e.g., a contact and wiper system, or a coiled wire system. An optional external magnetic strip allows the tool to magnetically adhere to a toolbox.

While the invention has been shown or described in only some of its forms, it should be apparent to those skilled in the art that it is not so limited, but is susceptible to various changes without departing from the scope of the invention. For example, the light and electromagnet assembly may be provided as a removable attachment on the end of the shaft, such that other types of attachments (e.g., mirrors, CCD camera, etc.) may be affixed to the tool.

1. A portable pick-up tool for retrieving magnetic objects that are located in hard-to-reach places, comprising:
a handle having a first compartment for supporting a battery, a second compartment for supporting a voltage regulator circuit, and a cover for concealing and providing access to only the first compartment;
a shaft having a proximal end mounted to the handle and a distal end, the shaft being telescopic, hollow, and flexible with respect to an axis thereof and having a collapsed position and an extended position;
a light mounted to the distal end of the shaft and coupled to the battery for illuminating objects in remote locations;
an electromagnet mounted to the distal end of the shaft and coupled to the battery for attracting and retaining magnetic objects thereon;
sliding and wiping electrical contacts mounted in the hollow shaft to provide power to the light and the electromagnet in both the collapsed and extended positions, the sliding and wiping contacts being in contact with and movable relative to each other;
a switch for allowing a user to direct the tool toward an object to be retrieved without the tool being attracted to surrounding magnetic components; and
a joint positioned in the shaft between a distal end of the shaft and the electromagnet for providing at least one additional degree of freedom of movement with respect to the shaft.

2. The pick-up tool of claim 1, wherein the electromagnet is tubular and the light is located concentrically within the tubular electromagnet.

3. The pick-up tool of claim 1, wherein the handle contains rechargeable batteries and couples to a charging stand to recharge the rechargeable batteries.

4. The pick-up tool of claim 1, wherein the handle is adapted to receive electrical power from a motor vehicle battery.

5. (canceled)

6. The pick-up tool of claim 1, wherein the joint is a ball joint that allows the light and electromagnet to swivel with respect to the shaft.

7. (canceled)

8. The pick-up tool of claim 1, wherein the switch is a momentary, double-throw switch.

9. The pick-up tool of claim 1, wherein the switch has a first position wherein both the light and the electromagnet are off, a second position wherein only the light is on, and a third position wherein both the light and the electromagnet are on.

10. The pick-up tool of claim 9, wherein the switch has a locking feature to alleviate a need for constant user engagement of the switch in each of the positions.

11. The pick-up tool of claim 1, further comprising a magnet mounted to the handle and adapted to allow the pick-up tool to magnetically adhere to and be retained on a magnetic object.

12. The pick-up tool of claim 1, wherein the light is selected from the group consisting of incandescent and light emitting diode (LED) lights.

13. A portable pick-up tool for retrieving magnetic objects that are located in hard-to-reach places, comprising:
a handle having a first compartment for supporting a rechargeable battery, a second compartment for supporting a voltage regulator circuit, a cover for concealing and providing access to only the first compartment, and a permanent magnet mounted to the handle and adapted to allow the pick-up tool to magnetically adhere to and be retained on a magnetic object, and the handle is adapted to receive electrical power from a motor vehicle battery;
a charging stand for coupling with the handle to recharge the rechargeable batteries;
a shaft having an axis, a proximal end mounted to the handle, and a distal end, the shaft being telescopic, hollow, and flexible with respect to the axis, and the shaft being movable between collapsed and extended positions;
sliding and wiping electrical contacts located in the hollow shaft to provide power to the light and the electromagnet in both the collapsed and extended positions;
a light mounted to the distal end of the shaft and coupled to the battery for illuminating objects in remote locations;
an electromagnet mounted to the distal end of the shaft and coupled to the battery for attracting and retaining magnetic objects thereon, the electromagnet being tubular and the light being located concentrically within the tubular electromagnet;
a momentary, double-throw switch for allowing a user to direct the tool toward an object to be retrieved without the tool being attracted to surrounding magnetic components, the switch having a first position such that both the light and the electromagnet are off, a second position such that only the light is on, and a third position such that both the light and the electromagnet are on;
a locking feature on the switch to alleviate a need for constant user engagement of the switch in each of the positions; and
a ball joint positioned in the shaft between a distal end of the shaft and the electromagnet for providing at least one additional degree of freedom of movement with respect to the shaft, the ball joint allowing the light and electromagnet to swivel with respect to the shaft.

14. (canceled)

15. (canceled)

16. (canceled)

17. (canceled)

18. (canceled)

19. (canceled)

20. (canceled)

21. The pick-up tool of claim 13, wherein the light is selected from the group consisting of incandescent and light emitting diode (LED) lights.
